(19) United States
(12) Patent Application Publication
(10) Pub. No.: US 2024/0410683 A1
(43) Pub. Date: Dec. 12, 2024

(54) Tracking Systems, Devices, And Associated Methods

(71) Applicants: Andrew Newcomb, Ashland, NE (US); Richard Kracum, Miami Beach, FL (US); Shane Wallace, San Diego, CA (US); S. Curtis Johnson, Racine, WI (US)

(72) Inventors: Andrew Newcomb, Ashland, NE (US); Richard Kracum, Miami Beach, FL (US); Shane Wallace, San Diego, CA (US); S. Curtis Johnson, Racine, WI (US)

(21) Appl. No.: 18/208,719

(22) Filed: Jun. 12, 2023

(51) Int. Cl. F42B 12/38; G01S 19/19

(52) U.S. Cl. CPC F42B 12/385; G01S 19/19

(57) ABSTRACT

The present invention is directed to a tracking system and method for a hunting arrow that implements a long range wide area network (LoRaWAN) protocol. The tracking device may include a LoRaWAN antenna, a global positioning system (GPS) antenna, and a projectile configured and adapted to support the tracking device.

### BACKGROUND

Hunting is a pastime and sport of cultural significance for many people across the world. When using certain hunting equipment, such as bows and arrows, a target animal may be wounded but may not succumb to an arrow immediately; instead, the target may travel a long distance before succumbing to its wound. Because it can be difficult to track such animals down, tracking devices have been used in connection with hunting for several years. In some systems, tracking devices have utilized global positioning system (GPS) receivers with arrows to relay information to a hunter using a radio transmission, cellular transmissions, and satellite data links. Several disadvantages exist with such systems, including the weight of the trackers, which affect the flight of the arrow, transmission range, and limited battery life.

### SUMMARY OF THE INVENTION

The present invention is directed to a tracking system and method that does not suffer from the shortcomings of the prior art. In some embodiments, the system comprises a tracking device configured and adapted to implement a long range wide area network (LoRaWAN) protocol. The tracking device may include a LoRaWAN antenna, a global positioning system (GPS) antenna, and a projectile configured and adapted to support the tracking device. In some embodiments, the tracking device may include an integrated rechargeable battery, which is configured to turn off prior to a predefined event, such as a battery damaging event. In some embodiments, the tracking device is configured and adapted to separate from the projectile, and preferably, is configured to remain attached to the animal. In certain embodiments, the tracking device includes an attachment prong to remain secured with the animal. In some embodiments, the tracking system may include a receiver configured to be in electronic communication with the tracking device, wherein the tracking device is configured and adapted to transmit a position signal to the receiver. Preferably, the position signal is updated and transmitted at a predetermined time period. The transmission may vary depending on how long it has been transmitting, e.g., every five minutes for the first two hours after the tracking device begins transmitting the position signal, every fifteen minutes for the next five hours, and every thirty minutes until the battery dies.

A method for using the tracking system may include determining a position of a tracking device using GPS satellites, sending the position of the tracking device to a receiver via a LoRaWAN protocol, and displaying position information on the receiver. In some embodiments, the method may further include determining if a target is alive using an acceleration profile or a temperature profile.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1A depicts a perspective view of a tracking system, in accordance with an exemplary embodiment of the present disclosure.

FIG. 1B depicts a detail view of a portion of a tracking system, in accordance with an exemplary embodiment of the present disclosure.

FIG. 1C depicts a detail view of a portion of a tracking system, in accordance with an exemplary embodiment of the present disclosure.

FIG. 1D depicts a frontal view of a tracking system, in accordance with an exemplary embodiment of the present disclosure.

FIG. 1E depicts a side view of a portion of a tracking system, in accordance with an exemplary embodiment of the present disclosure.

FIG. 2 depicts a detail view of a portion of a tracking system, in accordance with an exemplary embodiment of the present disclosure.

FIG. 3 depicts a flow diagram of using a tracking system, in accordance with an exemplary embodiment of the present disclosure.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION

The present disclosure describes preferred embodiment of a tracking system and associated methods according to the present invention.

Long Range Wide Area Network (LoRaWAN) is a type of Low Power Wide Area Network (LPWAN) that uses open-source technology and transmits over unlicensed frequency bands. LoRaWAN technology provides a far longer range than WiFi or Bluetooth connections, works well indoors, and is especially valuable for applications in remote areas where cellular networks have poor coverage. LoRaWAN provides several distinct advantages over cellular network transmission protocols in the context of tracking devices. For example, a tracking system employing a LoRaWAN tracking device can better preserve energy (e.g., of a battery) than merely a GPS-enabled tracker. In the context of airborne tracking devices, such as those implemented in a hunting application, minimizing the energy usage of a tracking device enables usage of a lightweight battery (relative to a battery necessary for a GPS-enabled tracker without LoRaWAN). LoRaWAN is traditionally used to deploy sensors with an existing LoRaWAN network, including a LoRaWAN network cloud. LoRaWAN has not been used in a hunting application, where there is not an existing network.

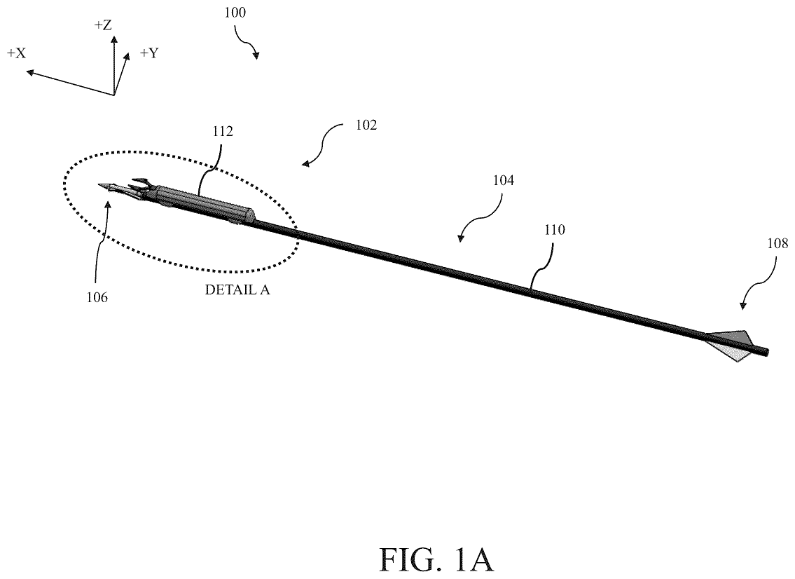

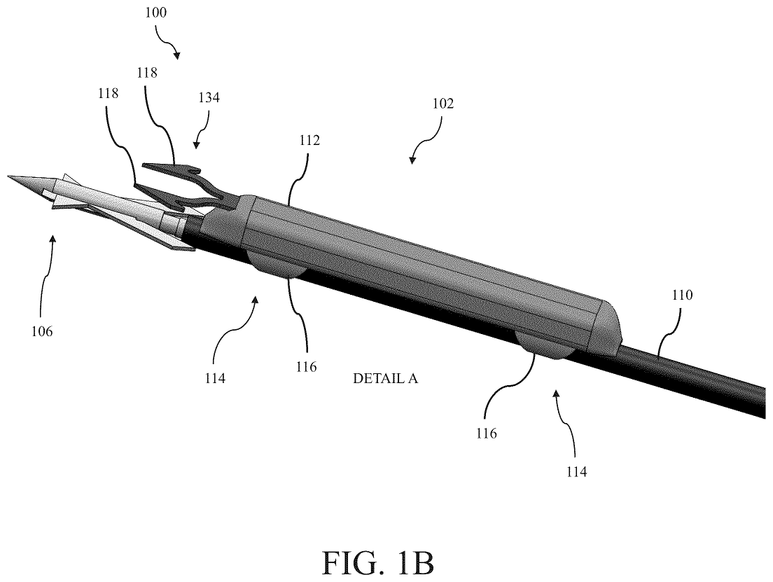

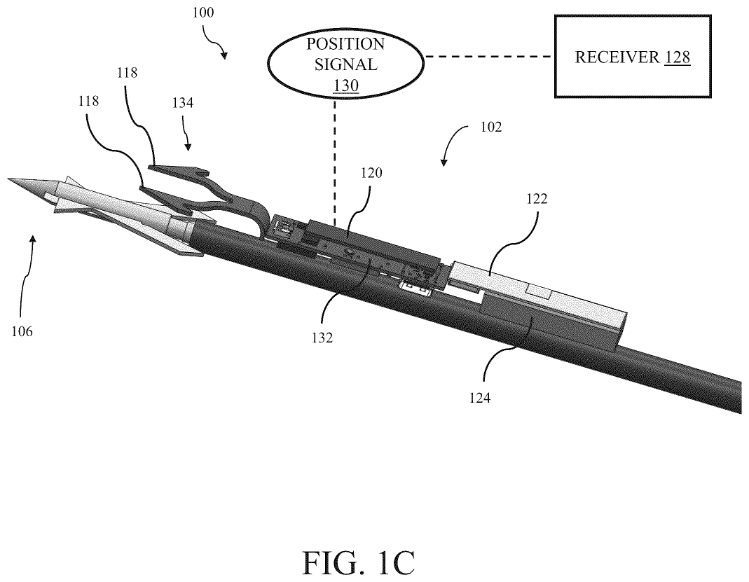

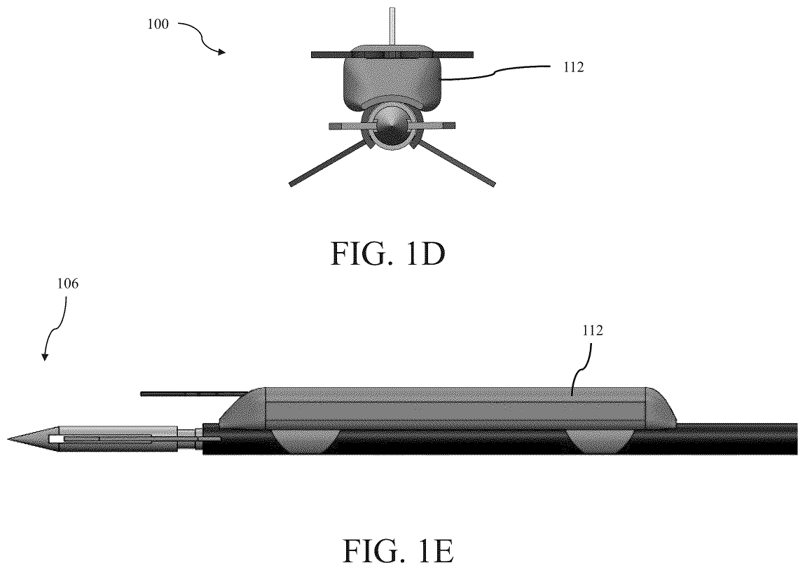

Referring now to the drawings, in FIGS. 1A-1E, a tracking system 100 is illustrated. Tracking system 100 includes a tracking device 102. Tracking device 102 can be configured and adapted to implement a long range wide area network (LoRaWAN) protocol. Referring now to FIG. 1A, tracking system 100 includes a projectile 104 (e.g., an arrow) configured and adapted to support tracking device 102. Projectile 104 includes a tip portion 106 at a proximal end, a base portion 108 at a distal end, and an elongated portion 110 (e.g., a shaft portion) extending from the proximal end to the distal end.

Referring now to FIG. 1B, tracking device 102 is illustrated including a housing 112. Housing 112 can be a plastic or composite component used to contain sensitive electronic components in a central area. Housing 112 can be 3D-printed, injection molded, or machined. Housing 112 can be a single, unitary piece or can be a plurality of pieces attached together.

Tracking device 102 can be configured and adapted to separate from projectile 104. For example, tracking device 102 can include attachment mechanisms 114. Attachment mechanisms 114 can include two pairs of prongs 116, or clips, which are configured to be concentric with elongated portion 110 such that tracking device 102 can slide along elongated portion 110 (e.g., when a tensile force exceeds a frictional force threshold). Tracking device 102 can be configured and adapted to attach to a target, such as an animal. For example, tracking device 102 can include a target attachment mechanism 134 including a plurality of attachment prongs 118. Attachment prongs 118 can be configured to pierce into an animal (e.g., the skin and/or flesh of an animal, such as a deer, or other wildlife). Attachment prongs 118 can be made from a variety of materials, including metal (e.g., aluminum or steel, such as those grades used in sheet metal), a plastic material, a composite material, or another material configurable to be sharp enough to pierce a target. Attachment prongs 118 and tracking device 102 can be configured such that the tracking device 102 will remain attached even when projectile 104 is removed from the animal (e.g., if the projectile 104 falls out).

Referring now to FIG. 1C, certain internal components of tracking device 102 are illustrated (where housing 112 is hidden for clarity). Tracking device 102 is illustrated including a LoRaWAN antenna 120 and a global positioning system (GPS) antenna 122. Tracking device 102 can include a circuit board 132 (e.g., a custom circuit board including a microprocessor, and the like). Tracking device 102 can include an integrated rechargeable battery 124. Integrated rechargeable battery 124 can be configured to shut off prior to the occurrence of a predefined event. In one embodiment, the predefined event can be a battery damaging event (e.g., when the charge falls below a certain level). In certain embodiments, the battery life can extend up to 24 hours.

Tracking device 102 can be configured and adapted to transmit a position signal 130 to a receiver 128 (e.g., a mobile receiver). Tracking device 102 can transmit the position signal 130 through a LoRaWAN, a low power wide area network (LPWAN), and/or a LoRa protocol. Position signal 130 can be transmitted to receiver 128 through LoRaWAN without cellular, WIFI, Bluetooth, or satellite network coverage. Position signal 130 can include information such as the latitude of tracking device 102, the longitude of tracking device 102, and/or the altitude of tracking device 102. Receiver 128 can display the latitude of tracking device 102, the longitude of tracking device 102, the altitude of tracking device 102, the bearings of tracking device 102, and/or the distance from receiver 128 to of tracking device 102. In certain embodiments, the position signal is updated and transmitted at a predetermined time period. In certain embodiments, the position signal is updated and transmitted every five minutes for the first two hours after the tracking device begins transmitting the position signal. In certain embodiments, the position signal is then updated and transmitted every fifteen minutes for the next five two hours. In certain embodiments, wherein the position signal is then updated and transmitted every thirty minutes until the battery dies. In certain embodiments, position signal can be a relatively small text file. In certain embodiments, other information (e.g., temperature measurements, acceleration measurements, or other measurements of various sensors of tracking device 102) can be transmitted to receiver 128.

In certain embodiments, tracking system 100 can operate in a range of 1 mile, 2 miles, 3 miles, 4 miles, and 5 miles. In certain embodiments, tracking system 100 can provide location accuracy within ±16 feet (i.e., a location diameter of 32 feet). In certain embodiments, tracking system 100 can be configured to track multiple tracking devices or projectiles (e.g., arrows).

In certain embodiments, tracking system 100 can include an accelerometer (e.g., a single axial accelerometer, a biaxial accelerometer, a triaxial accelerometer, etc.). Such an accelerometer can be positioned on housing 112 or circuit board 132. Such an accelerometer can be used to determine whether the target is deceased (e.g., where accelerations stop after a short period after impact), injured (e.g., where accelerations continue sporadically or constantly after impact), or uninjured (e.g., where accelerations are undetected after missing a target).

In certain embodiments, tracking system 100 can include a temperature measurement device (e.g., a thermocouple). The temperature measurement device can be used to measure the temperature of the target (e.g., a deer). The temperature measurement device can be attached to target attachment mechanism 134 and/or attachment prongs 118. Temperature measurements can be used to determine whether the target has been hit and whether the target is still alive. For example, the temperature measurement device can initially measure an initial ambient temperature (e.g., prior to launch). Temperature measurement device can then measure the body temperature of the target at the point of impact (e.g., when tip portion 106, target attachment mechanism 134, and/or attachment prongs 118 strike the target). The temperature measurement device can provide a temperature profile of the target as time elapses. In an example where the target is still alive, the temperature measurement device will measure (and provide to receiver 128) an approximately constant temperature reading, varying with the increases and decreases of the body temperature of the target. In an example where the target is deceased, the temperature measurement device will measure (and provide to receiver 128) a slowly decreasing temperature profile. In an example where tracking device 102 detaches from the target (deceased or alive), temperature measurement device will measure (and provide to receiver 128) a more rapidly decreasing temperature profile (i.e., as compared to an example where the tracking device is attached to a deceased target).

The accelerometer and/or temperature measurement device of tracking device 102 can be configured and adapted to preserve energy of tracking system 100 by changing the position transmission protocol. For example, if the acceleration profile and/or temperature profile indicate that the target is wounded (e.g., when accelerations are being detected and the temperature is at an elevated, relatively constant reading), tracking system 100 can use an increased transmission profile to aid a user in tracking the target. In another example, if the acceleration profile and/or temperature profile indicate that the target has been missed, tracking system 100 can use a decreased transmission profile to preserve energy (e.g., to avoid a long charging period prior to a subsequent use).

In certain embodiments, tracking system 100 can include an external charging contact. In one embodiment, tracking device 102 can include two leads such that tracking device can be set on a charging cradle (or a similar charging scheme) to charge prior to use. Tracking system 100 can include a variety of other charging schemes, such as using standard charging equipment like a USB-C charging port, micro-USB charging port, USB charging port, among others.

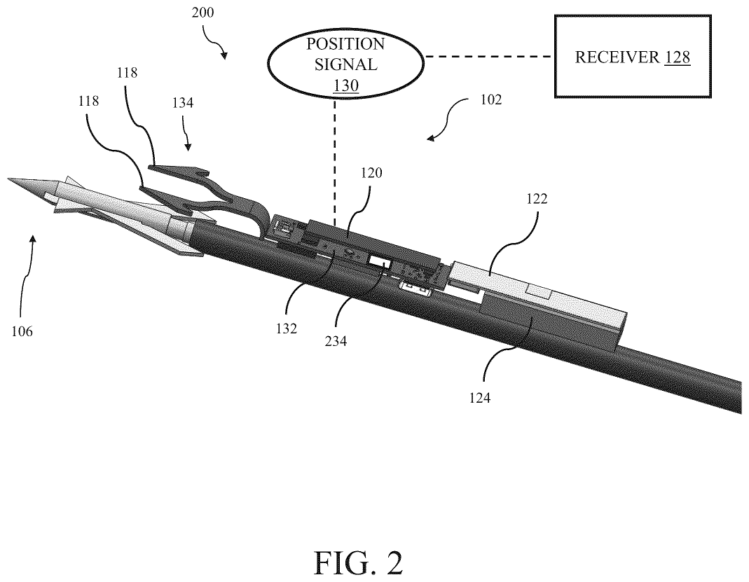

Referring now to FIG. 2, a portion of tracking system 200 is illustrated. Tracking system 200 is substantially the same as tracking system 100 except tracking system 200 includes an acceleration switch 234, where like elements are denoted with like reference numerals. Acceleration switch 234 (sometimes referred to as a “G-switch”) can be integrated with circuit board 132 and can provide a signal when tracking device 102 and/or projectile 104 accelerates above a given threshold (e.g., >1 G, >5 G's, >10 G's, 15 G's, 20 G's, >25 G's, >30 G's, >35 G's, >40 G's, >45 G's, >50 G's, >55 G's, etc.), such as when projectile 104 is launched from a bow. When tracking device 102 and/or projectile 104 accelerates above a given threshold, tracking system 200 can be configured to begin transmitting position signal 130 (and related information) to receiver 128. Acceleration switch 234 can be useful for preserving energy (e.g., by not using power consuming processes until the moment tracking device 102 and/or projectile 104 is launched) and improving operation of tracking system 200 (e.g., reducing useless prelaunch data, improving user friendliness, etc.).

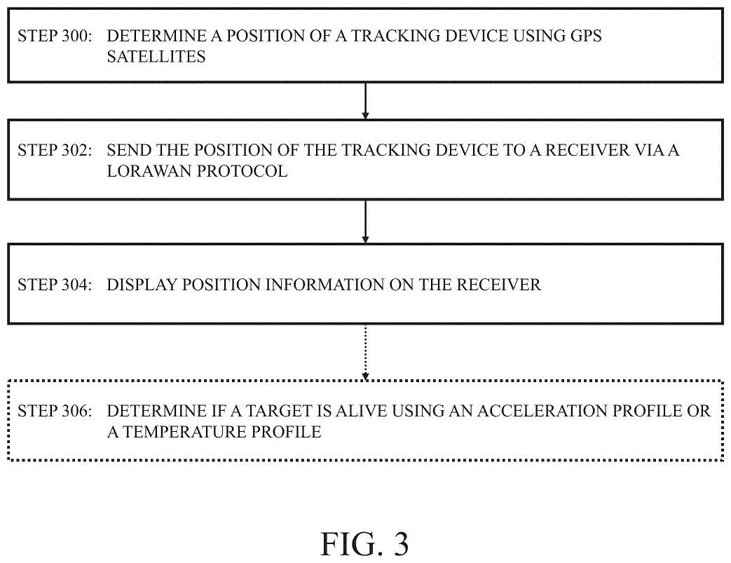

FIG. 3 is a flow diagram, in accordance with exemplary embodiments of the present disclosure. As is understood by those skilled in the art, certain steps included in the flow diagrams may be omitted; certain additional steps may be added; and the order of the steps may be altered from the order illustrated.

In Step 300, a position of a tracking device is determined using GPS satellites. In Step 302, the position of the tracking device is sent to a receiver (e.g., a mobile receiver) via a LoRaWAN protocol. In Step 304, position information is displayed on the receiver. In Step 306, a target can be determined to be alive using an acceleration profile or a temperature profile. For example, an acceleration profile from an accelerometer of tracking device 102 or a temperature profile from a temperature measurement device of tracking device 102 can be analyzed (e.g., locally or remotely) to determine if the target is alive. Accordingly, a transmission protocol (including the periodicity of transmission of position or other information) can be altered in view of the determination of Step 306. It should be noted that Step 306 can occur before or after any of Steps 300, 302, and 304.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A tracking system comprising:
a tracking device configured and adapted to implement a long range wide area network (LoRaWAN) protocol, the tracking device including:
a LoRaWAN antenna; and
a global positioning system (GPS) antenna; and
a projectile configured and adapted to support the tracking device.

2. The tracking system of claim 1, wherein the tracking device includes an integrated rechargeable battery, the integrated rechargeable battery being configured to shut off at prior to a predefined event.

3. The tracking system of claim 2, wherein the predefined event is a battery damaging event.

4. The system of claim 1, wherein the tracking device is configured and adapted to separate from the projectile.

5. The system of claim 1, wherein the tracking device is further configured and adapted to attach to an animal.

6. The system of claim 5, wherein the tracking device is configured and adapted to attach to an animal using an attachment prong.

7. The tracking system of claim 1, further comprising:
a receiver configured to be in electronic communication with the tracking device;
wherein the tracking device is configured and adapted to transmit a position signal to the receiver.

8. The tracking system of claim 7, wherein the position signal is updated and transmitted at a predetermined time period.

9. The tracking system of claim 8, wherein the position signal is updated and transmitted every five minutes for the first two hours after the tracking device begins transmitting the position signal.

10. The tracking system of claim 9, wherein the position signal is then updated and transmitted every fifteen minutes for the next five hours.

11. The tracking system of claim 10, wherein the position signal is then updated and transmitted every thirty minutes until the battery dies.

12. The tracking system of claim 1, wherein the tracking device includes a microprocessor.

13. The tracking system of claim 1, wherein the tracking device includes a temperature measurement device.

14. The tracking system of claim 13, wherein the temperature measurement device is a thermocouple.

15. The tracking system of claim 13, wherein the temperature measurement device is attached to an attachment prong of the tracking device.

16. The tracking system of claim 1, wherein the tracking device includes an accelerometer.

17. The tracking system of claim 1, wherein the tracking device includes an acceleration switch.

18. A method of using the tracking system of claim 1, comprising:
determining a position of a tracking device using GPS satellites;
sending the position of the tracking device to a receiver via a LoRaWAN protocol; and
displaying position information on the receiver.

19. The method of claim 18, further comprising:
determining if a target is alive using an acceleration profile or a temperature profile.
